(19) United States
(12) Patent Application Publication
(10) Pub. No.: US 2026/0178366 A1
(43) Pub. Date: Jun. 25, 2026

(54) MEMORY MANAGEMENT AND SHADOW QUEUEING IN HYPERVISOR ENVIRONMENTS

(71) Applicant: International Business Machines Corporation, Armonk, NY (US)

(72) Inventors: Walter Church, IV, Scotch Plains, NJ (US); Richard P. Tarcza, Kingston, NY (US); Justin VanSlocum, Mead, CO (US)

(21) Appl. No.: 19/001,206

(22) Filed: Dec. 24, 2024

(51) Int. Cl. G06F 9/455; G06F 11/07

(52) U.S. Cl. CPC G06F 9/45558; G06F 11/0772; G06F 2009/45579; G06F 2009/45583

(57) ABSTRACT

A present invention embodiment performs memory management and shadow queueing in a hypervisor environment. A queue is created in a hypervisor system that includes a host and a guest, wherein the queue is created in response to the guest issuing an I/O instruction, and wherein creating the queue comprises providing guest memory tables and corresponding shadow tables in the host that are accessed by an adapter. Data of the I/O instruction is stored to the guest memory tables, which are synchronized with the shadow memory tables, wherein the synchronizing comprises translating guest memory addresses into host memory addresses and pinning the guest memory addresses. A host unpin structure is provided with a copy of translated and pinned host memory addresses. In response to the adapter executing the I/O instruction, the host unpin structure is utilized, by the host, to locate and unpin the translated and pinned host memory addresses.

### BACKGROUND

### 1. Technical Field

Present invention embodiments relate to hypervisors and virtual machines, and more specifically, to memory management and shadow queueing in a hypervisor environment.

### 2. Discussion of the Related Art

A hypervisor refers to software and/or hardware that enables multiple operating systems, called guests or virtual machines, to run concurrently on a single physical computing device. A hypervisor manages physical resources, such as CPU, memory, storage, and networking, by allocating the resources to the guests, enabling each guest to operate as if it had its own dedicated hardware. When a guest issues input/output (I/O) instructions, the hypervisor synchronizes guest memory with a separate shadow memory that enables an adapter to access the data.

### SUMMARY

According to one embodiment of the present invention, a system is provided for memory management and shadow queueing in a hypervisor environment. A queue is created in a hypervisor system that includes a host and a guest, wherein the queue is created in response to the guest issuing an I/O instruction, and wherein creating the queue comprises providing guest memory tables in the guest and corresponding shadow tables in the host that are accessed by an adapter that executes the I/O instruction. Data of the I/O instruction is stored to the guest memory tables and the guest memory tables and the shadow memory tables are synchronized, wherein the synchronizing comprises translating guest memory addresses into host memory addresses and pinning the guest memory addresses. A host unpin structure is provided with a copy of translated and pinned host memory addresses. In response to the adapter executing the I/O instruction, the host unpin structure is utilized, by the host, to locate and unpin the translated and pinned host memory addresses. Embodiments of the present invention further include a method and computer program product for memory management and shadow queueing in a hypervisor environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of hypervisor code according to an embodiment of the present invention.

FIG. 3 is a block diagram of a virtualization environment according to an embodiment of the present invention.

FIG. 4 is a block diagram depicting memory structures according to an embodiment of the present invention.

FIG. 5 is a block diagram depicting a buffer according to an embodiment of the present invention.

FIG. 6 is a flowchart of a method of managing memory in a hypervisor environment according to an embodiment of the present invention.

### DETAILED DESCRIPTION

A present invention embodiment relates to hypervisors and virtual machines, and more specifically, to memory management and shadow memory in a hypervisor environment. In a hypervisor architecture, a hypervisor abstracts the physical hardware and presents virtual hardware to each guest (which are also referred to as virtual machines). This process of virtualization enables guests to behave as though each guest has its own independent hardware, even though multiple guests may share the underlying physical hardware elements. Thus, while devices may appear as physical hardware from the perspective of a guest, the devices may be virtualized by the hypervisor, meaning that the hypervisor intercepts and manages the instructions as the guest may not have access to the underlying physical hardware.

An Input/Output (I/O) instruction refers to a command issued by a guest to an adapter, which is an I/O device such as a processor, storage, memory, network interface, or other peripheral hardware. In some hypervisor architectures, the memory queues of I/O instructions are handled with shadow queues in the host. This shadow memory serves as a bridge between a guest's virtual memory and the physical memory of a hardware device. Since physical hardware does not directly access the virtual memory of a guest, the shadow memory is synchronized with the guest's virtual memory. The shadow memory is hosted in the hypervisor and managed by the hypervisor's control program, and unlike the guests' virtual memory, the shadow memory is accessible by the physical hardware.

Thus, when certain instructions are issued by a guest, the contents of the guest's memory are synchronized into the host memory in the form of a shadow queue so that an adapter can access the data. This synchronization involves moving data from storage block page entries of the guest memory into analogous storage block page entries in the shadow memory, pinning any storage block addresses so that the contents cannot be changed, and placing the contents into the host memory.

In certain architectures, such as the Enhanced Queued Direct Input/Output (EQDIO) architecture, the memory structure includes layers of memory that must be addressed in order to locate particular storage block page entries. Each layer of memory may reference a range of data that in turn references another range of data, ending with a layer that includes the actual data being processed. In particular, a storage block table (SBT) may reference entries in a storage block list (SBL), which in turn reference a storage block page (SBP) that ultimately stores the storage block page entries (i.e., the underlying data). In order to locate the correct storage block page entry (SBPE) according to conventional approaches, each memory layer must be addressed. Additionally, the guest memory structures are pinned so that the memory cannot be changed or moved. Constantly reacquiring the pinned host addresses using the guest addresses can be time-consuming. For example, if an SBT holds 16 SBL addresses, which can each hold 512 SBP addresses that in turn hold 256 or 512 SBP addresses, there can be thousands (e.g., 256k) of page addresses pinned in memory at once for a single queue. Thus, identifying specific host SBP addresses that must be unpinned can require a relatively substantial amount of time according to conventional approaches.

Another limitation of conventional hypervisor environments relates to determining how much work on a queue that an adapter has completed in order to perform shadow synchronization to move completed SBPE data from the shadow structure to the guest structure. Conventional approaches require monitoring of queues to determine how much work has been done in order to synchronize the results back into the guest memory.

The embodiments presented herein address these issues by implementing new data structures in order to provide improved techniques for managing data queues in hypervisor environments in which shadow structures are utilized. During queue creation, when a guest passes its queue structure to the host and shadow tables are created, the guest's addresses are translated to host memory addresses and pinned. Present invention embodiments provide a new data structure, a host unpin table, that stores these translated and pinned host addresses. Thus, instead of traversing the entirety of the shadow memory to find the translated and pinned addresses for a particular queue, the host unpin table can be accessed to perform tasks such as debugging if any guest corruption occurs. Additionally, the host unpin table enables pages to be unpinned even if the guest copy is destroyed, and error correction can be performed by traversing the guest structure to determine whether the translated pages still match the contents of the host unpin table.

Moreover, present invention embodiments enable queue progress tracking by providing a new buffer structure that includes both the old queue indexes and new queue indexes for comparison purposes. When a guest issues an instruction to retrieve the current queue index values from an adapter (e.g., a Store Adapter Indices (STAI) instruction), this instruction enables synchronization of I/O queue states between the guest, the host, and/or the adapter. Present invention embodiments provide a buffer in host memory that is twice the size of the contents transferred in a current queue index retrieval instruction (e.g., an STAI instruction). For example, if an STAI instruction requires a 256 bytes buffer, then the buffer that is allocated will be 512 bytes. The buffer stores new values from the adapter in the first 256 bytes, and the old values in the next 256 bytes representing the previous known state (i.e., queue index values) of the queue as stored by the host or guest. Thus, corresponding index values can be compared based on the offset (e.g., a 256-byte offset) between the new values and the old values in order to identify any differences. If there is a mismatch, then the queue is synchronized to the new index values. This buffer provides an improved mechanism for monitoring the progress of an adapter with respect to a queue.

Present invention embodiments thus improve the technical field of virtualization by providing techniques that improve management of memory in a hypervisor environment in which shadowing is implemented. In particular, pinned memory addresses can be more rapidly located, and queue progression may be better tracked. The embodiments presented herein provide several practical applications, including error detection and correction, resource optimization, and the like. For example, a buffer that includes old and new index values enables queue progression to be efficiently monitored while also providing for mismatch detection. As another example, the host unpin structure optimizes resources by enabling memory to be unpinned in a more efficient, quicker manner.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

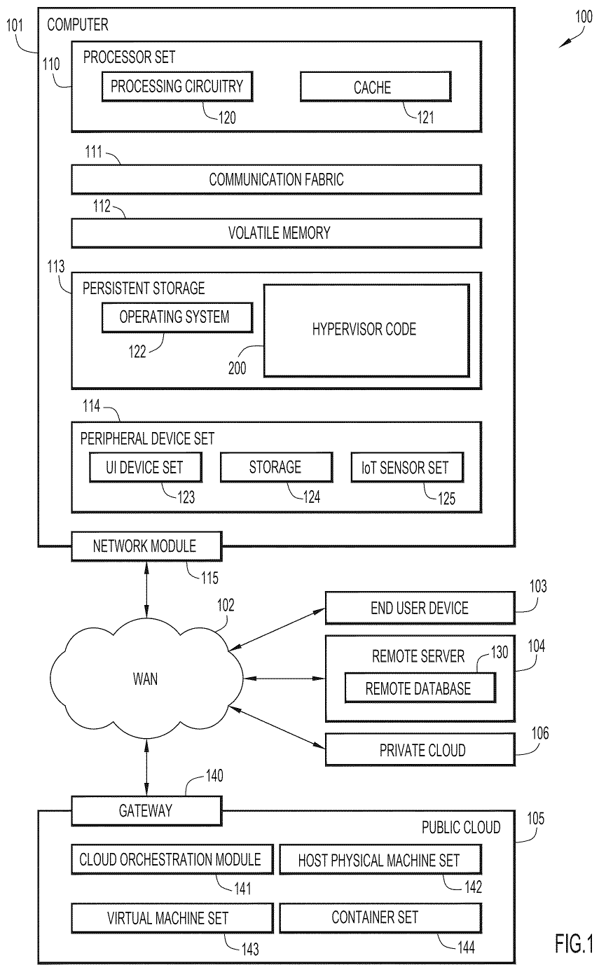

Referring to FIG. 1, computing environment 100 contains an example of an environment for the execution of at least some of the computer code involved in performing the inventive methods, such as hypervisor code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

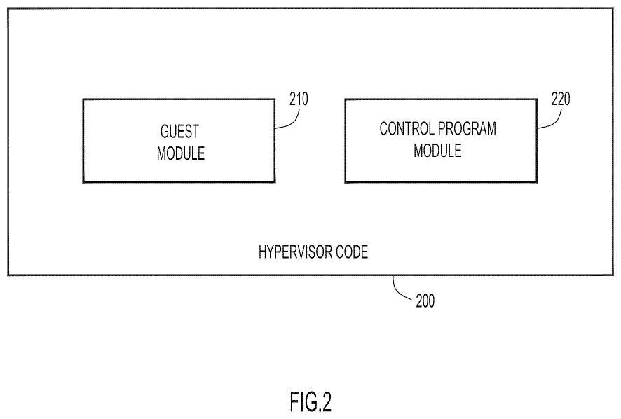

A block diagram of hypervisor code 200 according to an embodiment of the present invention is illustrated in FIG. 2. Specifically, hypervisor code 200 includes at least a guest module 210 and a control program module 220. Guest module 210 and control program module 220 may include one or more modules or units to perform various functions of present invention embodiments described herein. Guest module 210 and control program module 220 may be implemented by any combination of any quantity of software and/or hardware modules or units, and may reside within volatile memory 112 of computer 101 for execution by a processor, such as processor set 110.

Guest module 210 may include instructions for implementing one or more guests (i.e., virtual machines) of a hypervisor. Guest module 210 can include images of guests that can be instantiated and provided with resources by a host hypervisor, including virtual computing resources that can access the underlying physical hardware via the hypervisor. The guest module 210 may include an operating system and one or more programs (e.g., a word processor, a browser, etc.). Each guest may include various virtual devices, such as I/O devices like network interfaces, storage, graphics, and processors, and each guest may include virtual device drivers for each virtual device. Each guest may include virtual memory that is managed by the guest. In various embodiments, each guest may include monitoring tools that track computing resource usage within the guest environment, security components such as a firewall, user access control tools, authentication tools, and the like.

Control program module 220 may perform various operations relating to virtualization of guests/virtual machines by a hypervisor, including managing computing resources of guests in accordance with the embodiments presented herein. Control program module 220 may include a monitoring function that manages processor execution, including intercepting instructions that require hypervisor control. Control program module 220 may create guests and isolate guests from each other as well as the underlying hardware. A hypervisor kernel may be included that is similar to an operating system kernel; the hypervisor kernel can manage low-level hardware resources (e.g., processors, memory, I/O) and distribute these resources among the guests. Other functions of control program module 220 may include memory management functions, a scheduler for shared resources (e.g., physical hardware), security mechanisms, administrative access functions, and the like.

Control program module 220 may implement memory structures to manage shadowing of I/O queues and/or tracking of I/O queue progress as an adapter process a queue. In particular, a host unpin table may be implemented in the control program that tracks the host-translated and pinned memory addresses for a particular queue. Thus, when an adapter completes a queue and the memory contents must be unpinned, the host unpin table may be accessed to determine the specific addresses that are to be unpinned. This host unpin table can also be used for debugging in the case that guest corruption occurs: since pages are stored in the host unpin table, these pages can be unpinned even in the case of a guest losing its copy of queue structures. Thus, even if the guest queue structures are lost in guest memory, the host unpin table retains the data necessary to unpin all associated pages which held those structures.

Additionally or alternatively, control program module 220 can include a buffer for index values of an I/O instruction. This buffer may be twice the size of the number of index values associated with an instruction so that the buffer can hold an old copy of index values (i.e., the index values representing the previous known state of a queue as stored by the guest or host) as well as new index values obtained from the adapter. The new index values can be compared to the old index values to identify whether a mismatch has occurred, to track progression of the queue by an adapter, and the like.

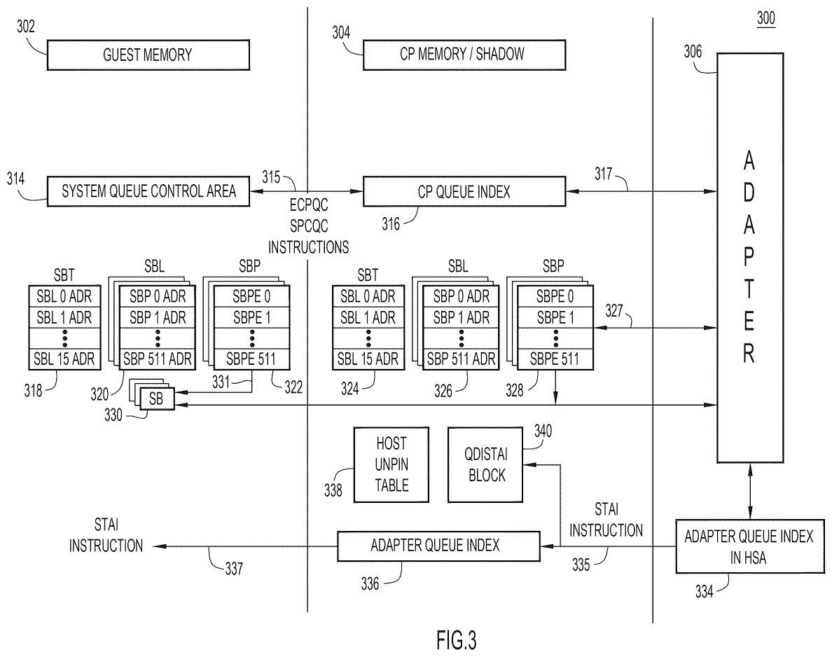

With reference now to FIG. 3, a block diagram is provided of a virtualization environment 300 according to an embodiment of the present invention. As depicted, the virtualization environment 300 includes guest memory 302, control program (CP) memory 304 (i.e., shadow memory), and an adapter 306. The guest memory 302 corresponds to virtual memory of a hypervisor's guest, and the CP memory 304 corresponds to shadow memory that is managed by the control program of a hypervisor. Adapter 306 may include any actual physical or virtual device (such as a network or storage adapter) with which a guest interacts. Adapter 306 may perform the I/O operations requested by a guest and is managed by the hypervisor through the shadowed structures. In some embodiments, adapter 306 is a virtual representation that corresponds to a physical device managed by the hypervisor through the shadow structures. Thus, I/O operations by a guest are taken out of the control program through the means of interception or interpretation.

Guest memory 302 includes a system queue control area 314, a Storage Block Table (SBT) 318, a Storage Block List (SBL) 320, a Storage Block Page (SBP) 322, and Storage Blocks (SBs) 330. CP memory 304 includes analogous shadow versions of some of these data structures, SBT 324, SBL 326, and SBP 328. CP memory 304 also includes CP Queue Index 316 and Adapter Queue Index 336.

System Queue Control Area 314 may be a control area that is configured to maintain information on various queues in guest memory, including the current status and configuration. As such, System Queue Control Area 314 may store details on queue priority, status flags, and/or the relationship between multiple queues.

SBT 318, SBL 320, and SBP 322 may include different levels or types of storage blocks for index values of issued instructions. SBT 318 may reference addresses in SBL 320, and SBL 320 may in turn reference addresses in SBP 322. For example, “SBL 0 ADR” may reference a 0 address in SBL 320, and “SBL 1 ADR” may reference a 1 address in SBP 322. SBP 322 may include entries (SBPEs) that represent the underlying data of I/O instructions, whereas SBL 320 references ranges of SBPEs, and in turn, SBT 318 references ranges of SBL 320 entries. SB 330 may include one or more memory blocks that store the actual data referenced by the index values of SBT 318, SBL 320, and SBP 322, as indicated by operation 331.

Any of SBT 318, SBL 320, and/or SBP 322 (and their analogous shadow counterparts SBT 324, SBL 326, and SBP 328) may be implemented as a ring buffer structure, which is a circular data structure. A ring buffer may be a fixed-size buffer that includes two pointers, a write pointer for placing new data into the buffer, and a read pointer for consuming or processing data from the buffer. When data is being written to, or read from, the ring buffer, and either the write or read pointer reaches the end of the buffer, the pointer will wrap around to the beginning (e.g., index 0) of the buffer, an occurrence referred to as a ring wrap. While this behavior allows for continuous use of the buffer space without the need to resize the buffer or move data around, in some cases, a ring wrap may cause data that is currently being used by an element (e.g., adapter 306) to be overwritten.

CP memory 304 may include several shadow structures that are analogous to their counterparts in guest memory 302, and may be synchronized with the corresponding analogous structures to enable data access by adapter 306. The shadow structures include SBT 324, SBL 326, and SBP 328. The shadow structures enable the hypervisor to track and manage guest memory mappings accurately, ensuring that I/O operations are handled correctly without compromising isolation between guests. SBP 328 may receive output (i.e., the output results of an I/O operation) from adapter 306 at operation 327, which can be provided to SB 330 at operation 329.

Also included in CP memory 304 is a CP Queue Index 316, which maintains the current state of the queues being used by the hypervisor for tracking guest operations. The CP Queue Index 316 enables the CP to determine the next or current operation to process. The CP Queue Index 316 may synchronize instructions with System Queue Control Area 314 (operation 315). These instructions may include Extract CP Queue Controls (ECPQC) and/or Store CP Queue Controls (SCPQC), and may manage the queue structures by updating queue indices, enqueuing requests, and/or synchronizing queue states between guest and CP memory. In particular, the SCPQC instruction may be issued to store a new index for an adapter to be informed that there are new SB pages to process, whereas the ECPQC is issued to recover the last CP indexes in order to determine state of the current processing for each queue entry/index. CP Queue Index 316 may receive data from adapter 306, as shown at operation 317, including new indexes being filled to use with the SCPQC.

The Adapter Queue Index 336 may may synchronize with the adapter queue index in the hardware system area (HSA) 334 to forward Store Adapter Index (STAI) instructions (operation 335), which are then provided to the guest (operation 337). The STAI instructions may then be provided to the guest at operation 337. The STAI instructions provide the adapter indexes for all queues; as such, STAI instructions can obtain all input or output queue indexes to determine how much work has been done by the adapter 306 An STAI instruction may be used to determine whether there are pages to recover. Adapter Queue Index 336 also synchronize with the CP Queue Index 316 to ensure that the guest and CP views of the queue state align with the view of adapter 306.

Host unpin table 338 may include a data structure that stores addresses of guest queue structures (i.e., contents of SBT 318, SBL 320, and SBP 322) that have been translated into host memory and pinned. A translated address is an address in physical memory of a host that corresponds to the virtual address in guest memory having the same contents. When an address is pinned, the contents of the address cannot be changed until unpinned, enabling an adapter to process the data without concern for the data being modified during processing, as pinning prevents the locations of guest memory from moving into host memory due to paging actions. Host unpin table 338 may thus store a copy of the translated and pinned addresses corresponding to a queue for an I/O device, such as an EQDIO device. Host unpin table 338 may be allocated in a queue I/O block (QIOBK), which is a queue information block for a specific queue on a device.

Queued Direct I/O STAI (QDISTAI) block 340 may include a buffer that stores index values for I/O instructions. When an STAI instruction is issued, the STAI instruction obtains all input or output queues from an adapter (e.g., adapter 306). The indexes for the queues obtained from STAI instructions can be stored in the QDISTAI block 340 for comparison purposes. In particular, QDISTAI block 340 may be twice the size of an STAI instruction's index values, enabling QDISTAI block 340 to store index values for two STAI instructions. QDISTAI block 340 may store a set of index values that correspond to the last known state of processing of a queue that is known by a guest, and another set of index values that correspond to the current state of queue processing by an adapter. Shadow synchronization code in the host may check each index in the QDISTAI block 340 by comparing each index value of the previous state of the queue to the corresponding index value of the more recently-obtained set to determine how much work has been done by the adapter since the guest memory was last synchronized. This comparison can be used to determine when to update guest memory and resynchronize the shadow memory with the guest memory.

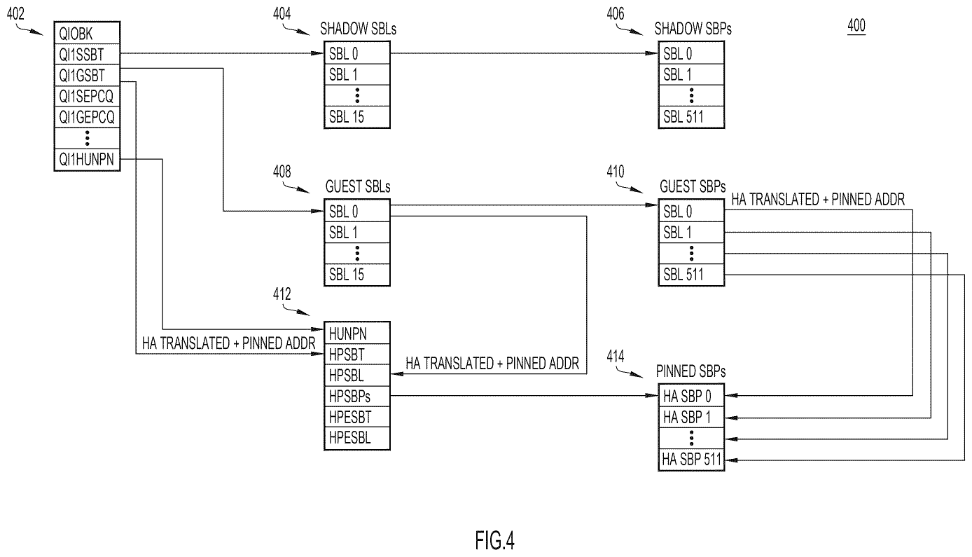

FIG. 4 is a block diagram depicting memory structures 400 according to an embodiment of the present invention. As depicted, the memory structures 400 include a queue I/O block (QIOBK) 402, shadow SBLs 404, shadow SBPs 406, guest SBLs 408, guest SBPs 410, a host unpin (HUNPN) table 412, and pinned SBPs 414.

QIOBK 402 is a control block for a particular queue (e.g., an EQDIO queue) that is being processed using an adapter. QIOBK 402 references other blocks, including the shadow memory blocks and guest memory; HUNPN table 412 may be implemented within QIOBK 402 in a dedicated area of memory. As shown, guest SBLs 408 reference guest SBPs 410, and likewise, shadow SBLs 404 reference shadow SBPs 406. The shadow structures are synchronized with the guest data to provide a host and adapter access to the data.

Since the guest memory structures are implemented using virtual addresses, the addresses are translated into host absolute (HA) addresses that represent the physical memory addresses in hardware of the host. These translated and pinned addresses are stored in host unpin table 412, which stores the pinned SBPs 414 for a particular queue of an adapter.

Thus, a copy of the pinned and translated addresses for a queue are stored in a same location for referencing in accordance with the embodiments presented herein. The host unpin table 412 enables contents to be moved into the shadow queue for the adapter without having to retranslate the addresses. Moreover, the host unpin table 412 enables the host to more efficiently locate the pinned addresses later for cleanup after a queue is processed, as the contents of the host unpin table 412 indicate the specific addresses that require unpinning. Since the host unpin table 412 stores a snapshot of addresses when queues are created, the guest structures can be traversed and retranslated to determine whether the guest addresses match the addresses in the host unpin table 412. If there is a mismatch between the addresses in the host unpin table 412 and the guest addresses, this mismatch indicates that the guest addresses are not correct and that the guest should perform error correction.

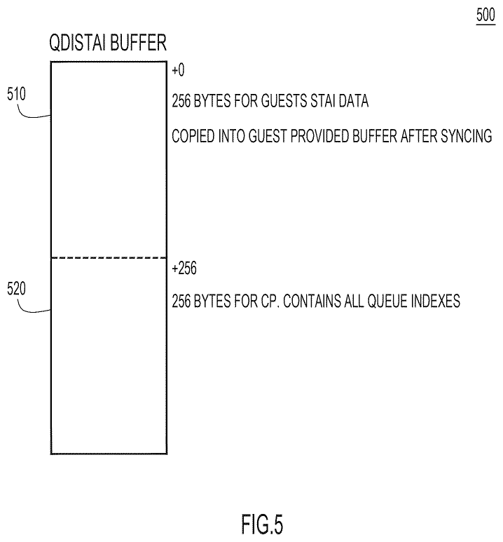

With reference now to FIG. 5, a block diagram is provided depicting a buffer 500 according to an embodiment of the present invention. As shown, buffer 500 may be a QDISTAI buffer that includes two areas, current index values 510 and previous index values 520. Buffer 500 may store corresponding index values for each of the current index values 510 and the previous index values 520 offset from each other by a predetermined number of bytes. In the depicted example, buffer 500 is 512 bytes, with the current index values 510 being stored in the first 256 bytes, and the previous index values 520 being stored in the next 256 bytes. In this example, an STAI instruction includes 256 bytes of index values, so buffer 500 can store index values corresponding to two STAI instructions (e.g., a current state and previous known state). This structure enables current and previous indexes to be checked by comparing an index value to another index value that is 256 bytes apart. Thus, in the depicted example, the buffer 500 stores STAI data obtained from an adapter in the first 256 bytes (current index values 510), and the previous queue indexes in the control program in the next 256 bytes (previous index values 520). The previous index values 520 can checked against the new index values (current index values 510) to determine whether a queue should be synchronized.

When a guest SCPQC instruction is intercepted and the host issues an ECPQC instruction, the host also issues an internal STAI instruction to acquire the latest adapter index values. These latest adapter index values indicate the current state of processing of a queue by the adapter. By comparing the new index values to the previous index values, the amount of progress by an adapter on a queue can be determined. If the new index values are greater than the old index values, then entries between the old and new indexes have been processed by the adapter. Thus, synchronization is needed to update the guest's view. However, if the new index values are beyond a threshold amount greater than the old index values, this could indicate an amount of processing by the adapter that is not expected given the amount of time that has elapsed, potentially indicating an error. If the new index values are equal to the old index values, no new data has been processed, so no synchronization is required. If the new index values are lower than the old index values, this may indicate an error in the adapter and/or the guest, and the adapter and/or guest may be error-checked. However, if the new index values are lower than the old index values, a ring wrap may have occurred, which can be verified by the hypervisor.

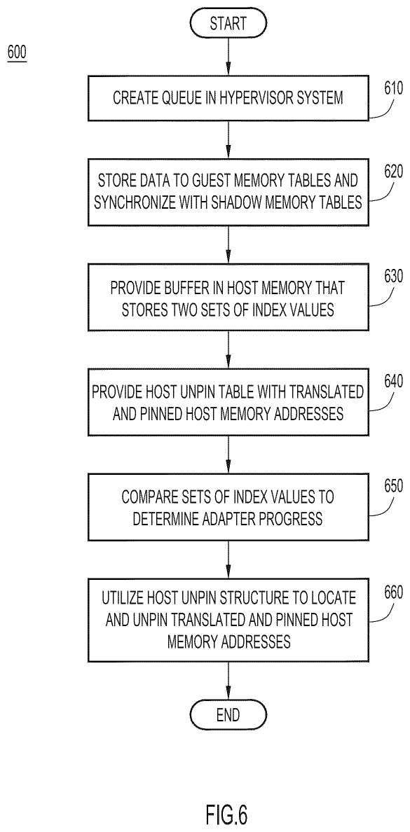

With reference now to FIG. 6, a flowchart is provided of a method 600 of managing memory in a hypervisor environment according to an embodiment of the present invention.

A queue is created in a hypervisor system at operation 610. The queue may be created in relation to a guest issuing an I/O instruction that is intercepted by the host so that an adapter can process the I/O instruction. Guest memory tables and corresponding shadow memory tables in the host are provided that enable an adapter to access the data of the queue, as an adapter may not directly access guest memory. Upon creation of the queue, a host unpin table may also be provided in a queue-specific I/O block in host memory. Additionally or alternatively, a buffer may be provided in host memory that stores at least two sets of index values for a queue.

Data is stored to guest memory tables and the shadow memory tables are synchronized with the guest memory tables at operation 620. Data of the I/O instruction is stored to guest memory tables, which can include two or more layers of tables in which each table references another in a hierarchical manner. For example, there may be an SBT that includes index values referencing entries in an SBL, which in turn includes index values that reference entries in an SBP (which may ultimately store the data). Analogous structures in the host memory, referred to as shadow memory tables, may be provided and synchronized with the contents of the guest memory tables.

A buffer is provided in host memory that stores two sets of index values at operation 630. The buffer can store index values associated with an I/O instruction; for example, if the index values occupy 256 bytes, then a 512-byte buffer may be allocated in aligned memory to store two sets of index values. A first set of index values may include new index values obtained from an adapter, which reflect the adapter's current progress of queue processing, whereas a second set of index values may include previous index values that correspond to a last known state of the queue's processing by the guest.

The host unpin structure is provided with translated and pinned host memory addresses at operation 640. When guest data is translated into host absolute addresses (e.g., actual memory addresses of the host rather than virtual guest memory addresses), the translated addresses that are also pinned in the host for processing of the queue are stored in the host unpin structure. Thus, present embodiments avoid having to re-translate guest addresses each instance that a host address is sought.

The sets of index values in the buffer are compared to determine adapter progress at operation 650. The new set of index values obtained from the adapter (e.g., via an STAI instruction) may be compared to the previous set of index values of the guest to identify differences between the index values. Thus, progress of the adapter can be determined, which can inform the host that the guest memory should be updated and the shadow tables should subsequently be resynchronized. Moreover, any errors in the guest memory can be identified based on a mismatch in this comparison.

The host unpin structure is utilized to locate and unpin translated and pinned memory addresses at operation 660. After processing of an I/O instruction (i.e., in response to the adapter executing the I/O instruction), the host unpin structure may be utilized by the host to quickly locate and unpin any memory addresses whose contents are no longer required to be pinned. Additionally, the host unpin structure may be traversed to identify whether there is a mismatch between pinned guest addresses, which can be indicative of corruption of the guest. Thus, a guest may be informed that error correction should be performed in response to a mismatch.

It will be appreciated that the embodiments described above and illustrated in the drawings represent only a few of the many ways of implementing embodiments for improved memory management with respect to I/O instructions in a hypervisor environment.

The environment of the present invention embodiments may include any number of computer or other processing systems (e.g., any computing device, computing service, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., hypervisor code 200, elements of virtualization environment 300, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the computing system. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., guest data, virtual device data, hypervisor data, buffer data, queue data, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The guest data, virtual device data, hypervisor data, buffer data, queue data, guest memory data, shadow memory data, and/or any other data may include any information arranged in any fashion, and may be configurable based on rules or other criteria to provide desired information to a user.

The present invention embodiments are not limited to the specific tasks or algorithms described above, but may be utilized for improving execution of I/O instructions in any virtualization environment.

The data may include any format of storing data and may include any data descriptive of databases, including metadata and indexes thereof. The data may be obtained via any techniques, and may be accessed over a network, fetched from local storage, provided via user input, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
creating a queue in a hypervisor system that includes a host and a guest, wherein the queue is created in response to the guest issuing an I/O instruction, and wherein creating the queue comprises providing guest memory tables in the guest and corresponding shadow memory tables in the host that are accessed by an adapter that executes the I/O instruction;
storing data of the I/O instruction to the guest memory tables and synchronizing the guest memory tables and the shadow memory tables, wherein the synchronizing comprises translating guest memory addresses into host memory addresses and pinning the guest memory addresses;
providing a host unpin structure with a copy of translated and pinned host memory addresses; and
in response to the adapter executing the I/O instruction, utilizing, by the host, the host unpin structure to locate and unpin the translated and pinned host memory addresses.

2. The computer-implemented method of claim 1, further comprising:
traversing the host unpin structure by the host to detect a mismatch between the translated and pinned host memory addresses and the guest memory addresses; and
in response to detecting the mismatch, indicating the mismatch to the guest.

3. The computer-implemented method of claim 1, further comprising:
providing a buffer in host memory that stores two sets of index values for a queue being processed by the adapter, wherein the buffer stores a first set of index values currently obtained from the adapter and a second set of index values previously obtained from the adapter.

4. The computer-implemented method of claim 3, further comprising:
comparing the first set of index values to the second set of index values to determine that the adapter has made progress on the queue; and
updating the guest memory tables with output of the adapter corresponding to the progress.

5. The computer-implemented method of claim 3, further comprising:
comparing the first set of index values to the second set of index values to determine that the guest has encountered an error; and
indicating to the guest that the error has occurred.

6. The computer-implemented method of claim 3, wherein the buffer is allocated during creation of the queue.

7. The computer-implemented method of claim 1, wherein the host unpin structure is stored in a queue I/O block associated with a particular virtual device of the guest.

8. A computer system comprising:
a processor set;
one or more computer-readable storage media; and
program instructions stored on the one or more computer-readable storage media to cause the processor set to perform operations comprising:
creating a queue in a hypervisor system that includes a host and a guest, wherein the queue is created in response to the guest issuing an I/O instruction, and wherein creating the queue comprises providing guest memory tables in the guest and corresponding shadow memory tables in the host that are accessed by an adapter that executes the I/O instruction;
storing data of the I/O instruction to the guest memory tables and synchronizing the guest memory tables and the shadow memory tables, wherein the synchronizing comprises translating guest memory addresses into host memory addresses and pinning the guest memory addresses;
providing a host unpin structure with a copy of translated and pinned host memory addresses; and
in response to the adapter executing the I/O instruction, utilizing, by the host, the host unpin structure to locate and unpin the translated and pinned host memory addresses.

9. The computer system of claim 8, wherein the program instructions further cause the processor set to perform operations comprising:
traversing the host unpin structure by the host to detect a mismatch between the translated and pinned host memory addresses and the guest memory addresses; and
in response to detecting the mismatch, indicating the mismatch to the guest.

10. The computer system of claim 8, wherein the program instructions further cause the processor set to perform operations comprising:
providing a buffer in host memory that stores two sets of index values for a queue being processed by the adapter, wherein the buffer stores a first set of index values currently obtained from the adapter and a second set of index values previously obtained from the adapter.

11. The computer system of claim 10, wherein the program instructions further cause the processor set to perform operations comprising:
comparing the first set of index values to the second set of index values to determine that the adapter has made progress on the queue; and
updating the guest memory tables with output of the adapter corresponding to the progress.

12. The computer system of claim 10, wherein the program instructions further cause the processor set to perform operations comprising:
comparing the first set of index values to the second set of index values to determine that the guest has encountered an error; and
indicating to the guest that the error has occurred.

13. The computer system of claim 10, wherein the buffer is allocated during creation of the queue.

14. The computer system of claim 8, wherein the host unpin structure is stored in a queue I/O block associated with a particular virtual device of the guest.

15. A computer program product comprising:
one or more computer-readable storage media; and
program instructions stored on the one or more computer-readable storage media to perform operations comprising:
creating a queue in a hypervisor system that includes a host and a guest, wherein the queue is created in response to the guest issuing an I/O instruction, and wherein creating the queue comprises providing guest memory tables in the guest and corresponding shadow memory tables in the host that are accessed by an adapter that executes the I/O instruction;
storing data of the I/O instruction to the guest memory tables and synchronizing the guest memory tables and the shadow memory tables, wherein the synchronizing comprises translating guest memory addresses into host memory addresses and pinning the guest memory addresses;
providing a host unpin structure with a copy of translated and pinned host memory addresses; and
in response to the adapter executing the I/O instruction, utilizing, by the host, the host unpin structure to locate and unpin the translated and pinned host memory addresses.

16. The computer program product of claim 15, wherein the program instructions further perform operations comprising:
traversing the host unpin structure by the host to detect a mismatch between the translated and pinned host memory addresses and the guest memory addresses; and
in response to detecting the mismatch, indicating the mismatch to the guest.

17. The computer program product of claim 15, wherein the program instructions further perform operations comprising:
providing a buffer in host memory that stores two sets of index values for a queue being processed by the adapter, wherein the buffer stores a first set of index values currently obtained from the adapter and a second set of index values previously obtained from the adapter.

18. The computer program product of claim 17, wherein the program instructions further perform operations comprising:
comparing the first set of index values to the second set of index values to determine that the adapter has made progress on the queue; and
updating the guest memory tables with output of the adapter corresponding to the progress.

19. The computer program product of claim 17, wherein the program instructions further perform operations comprising:
comparing the first set of index values to the second set of index values to determine that the guest has encountered an error; and
indicating to the guest that the error has occurred.

20. The computer program product of claim 17, wherein the buffer is allocated during creation of the queue.
